(19) United States
(12) Patent Application Publication
(10) Pub. No.: US 2016/0369828 A1
(43) Pub. Date: Dec. 22, 2016

(54) Assembly For and Method of Affixing a Fastener to a Panel

(71) Applicant: Penn Engineering & Manufacturing Corp., Danboro, PA (US)

(72) Inventor: Trevor Fahy, Galway (IE)

(21) Appl. No.: 15/185,471

(22) Filed: Jun. 17, 2016

Related U.S. Application Data
(60) Provisional application No. 62/181,343, filed on Jun. 18, 2015.

(51) Int. Cl. F16B 5/02; F16B 37/00

(52) U.S. Cl. CPC F16B 5/0258; F16B 37/005

(57) ABSTRACT

Attachment of a rectangular clinch fastener is achieved with the panel receiving hole side-gaps at least partially closed by features incorporated into the installation tooling. Panel displacement features are added to the face of the installation anvil tool to draw from the panel material and move this material inwardly up against the side face of the fastener thus greatly closing the receiving hole side gaps. The anvil features include two raised displacer protrusions extending above the pressing surface of the anvil aligned with the non-clinching side edges of a rectangular tool well. The anvil features have a trapezoidal shape with a slanted face facing inwardly such that upon installation the panel is deformed to close or greatly reduce the length of the unwanted side edge gaps.

### RELATED APPLICATIONS

This application is a non-provisional patent application of provisional patent application No. 62/181,342 entitled “Side Gap Closure Tool for a Clinch Nut” filed Jun. 18, 2015, priority from which is hereby claimed.

### FIELD OF THE INVENTION

The present invention relates to the attachment of clinch type metal fasteners to a deformable metal panel. More specifically it relates to these clinch fasteners having a rectangular base which attaches to the panel.

### BACKGROUND OF THE INVENTION

Metal clinch fasteners have an attachment base which can be round or other geometric shape. Clinch fasteners are often rectangular at their point of attachment and can be received in a rectangular hole in the target panel or can be piercing in which case they cut a receiving hole into the panel as they are installed. An example of a rectangular clinch fastener is the R′Angle® fastener manufactured by Penn Engineering of Danboro, Pa., U.S. and as disclosed in U.S. Pat. No. 5,810,501 entitled “Perpendicular Edge Fastener”, which is incorporated here by reference as though fully set forth.

FIGS. 1-3 show this prior art fastener and how it has been employed to attach two panels at right angles. The fastener 8 is a non-piercing clinch type described above which is installed in a pre-cut rectangular hole. A screw 30 affixes the second panel 14 to the right angle fastener. The fastener 8 is applied from the backside of panel 16 as seen more clearly in FIG. 2 utilizing the anvil shown in both illustrations of FIG. 2.

Referring now to FIG. 2, the fastener 8 is attached to the panel 13 on two opposite longitudinal sides of the rectangular base of the fastener, each having clinch features which accept material from the attached panel as the fastener is pressed in. The fastener 8 is pressed in by a punch 10 against anvil 9 that has a well 17 that receives the top end of the inverted fastener. The pre-cut hole in panel 16 is necessary a little larger than the lateral width of the fastener 8 to provide an assembly tolerance. As seen in FIG. 3, this leaves gaps 18 in the receiving hole on the non-clinching sides of the fastener.

A problem exists with panel assemblies in the electronics communications industry where this type of clinch fastener is installed through the exterior panels in electronics enclosures. The enclosures may contain radio communication components or high frequency processor electronics. In many of these cases assembled enclosures require testing and certification to demonstrate that they adequately prevent transmission of electromagnetic radiation which may cause interference with other electronic devices in the surrounding environment. Openings in the exterior enclosure panels are to be avoided since they can become EMI transmitters if the opening length is relatively long such as a long thin slot. As seen in FIG. 3, a clinch fastener side gap can create such an undesirable opening unless it is significantly shortened.

The use of specialized tooling to facilitate the attachment of fasteners to panels is known for example in the field of piercing fasteners. U.S. patent application 2005/0210651 discloses a panel supporting anvil with projections that force panel material outwardly and upwardly into grooves in the bottom of the fastener. There are no side gaps problems in this example because the fastener is self-piercing and the sides are in contact with the receiving panel. However, there is no known tooling or process which moves panel material inwardly toward the body of the fastener to bridge a tolerance gap between the side of the fastener and the panel,

There is therefore a need in the art for a system of installing a fastener with a rectangular base into the exterior panel of electronics equipment which does not leave undesirably long openings in the panel adjacent the fastener that would interfere with the operation of the device. There is a further need for a method of installing a right-angle clinch fastener without a resulting long gap between the fastener and the receiving panel.

### SUMMARY OF THE INVENTION

The present invention has been devised to meet the need in the art to solve the side gap problem described above. Attachment of a rectangular clinch fastener is achieved with the side gaps at least partially closed by features incorporated into the installation tooling. In one embodiment panel displacement features are added to the face of the installation anvil tool to draw from the panel material and move this material inwardly up against the side face of the fastener thus greatly closing the side gaps. The anvil features include two raised displacer protrusions extending above the pressing surface of the anvil which are aligned with the non-clinching side edges of a rectangular tool well. The anvil features have a trapezoidal shape with a slanted face facing inwardly such that upon installation the panel is deformed to close or greatly reduce the length of the unwanted side edge gaps.

More specifically the applicant has invented a method of attaching a fastener with a rectangular base to a panel having a rectangular receiving hole, comprising the steps of first; placing a panel with a rectangular receiving hole having a length and a width against a top of an anvil having a pressing surface with upward extending projections, said anvil having a well extending downward directly below said hole; next, placing a fastener with a rectangular base through the receiving hole against a top of the panel and partially into the anvil well, said base having two pairs of parallel opposing sides, a first pair of longitudinal sides having undercuts for receiving the cold flow of material from the panel defining a length of said base and a second pair of lateral sides being planar and featureless and defining a width of said base, the width of said base being less than the receiving hole width such that gaps in the hole exist between the lateral pair of sides of said base and the panel; and then pressing said fastener against the panel and the anvil whereby said projections on the anvil pressing surface displace material of said panel inwardly into said gaps and against the second pair of side edges such that medial portions of said gaps are fully closed while simultaneously material of the panel is forced into said undercuts attaching the fastener to the panel.

This method results in an assembly of a fastener affixed to a panel, comprising a panel having a rectangular receiving hole with a length and a width. A fastener with a rectangular base extends through the receiving panel hole, said base having two pairs of parallel opposing sides, a first pair of longitudinal sides having undercuts receiving the cold flow of material from the panel and a second pair of lateral featureless planar sides. Gaps between the lateral sides of the fastener base and the panel have medial portions fully closed against the lateral sides of the fastener by the deformation of the panel material performed during attachment of the fastener to the panel.

It is therefore an object of the invention to create a fastener-to-panel assembly for fasteners with a rectangular base which does not produce side gaps that are undesirably long so that unwanted EMF transmissions are avoided. This and other objects and advantages will be apparent from the following drawings and description of the preferred embodiment. In this respect, before explaining at least one embodiment of the invention in detail, it is to be understood that the invention is not limited in its application or to the details of construction in the following description or illustrated in the drawings. The invention is capable of other embodiments and of being carried out in various ways.

### BRIEF DESCRIPTION OF THE DRAWINGS

FIG. 1 is a top right front perspective assembly view showing an example of a right angle fastener as it is used to attach two panels at right angles as known in the prior art.

FIG. 2 is an illustration showing a top plan view and a partially sectioned front elevation view of standard installation press tooling of the prior art.

FIG. 3 is a top plan view showing side-edge gaps of an installed fastener of the prior art.

FIG. 4 is a top right front perspective view of the anvil tooling of the invention.

FIG. 5 is a front sectional elevation view of taken from FIG. 4 as shown in that figure.

FIG. 6 are a side elevation partial cross-section views showing a before-and-after installation sequence.

FIG. 7 is a top front perspective view of an installed fastener in accordance with the invention which depicts displaced panel material moved against one side of the fastener closing a major portion of the front side gap.

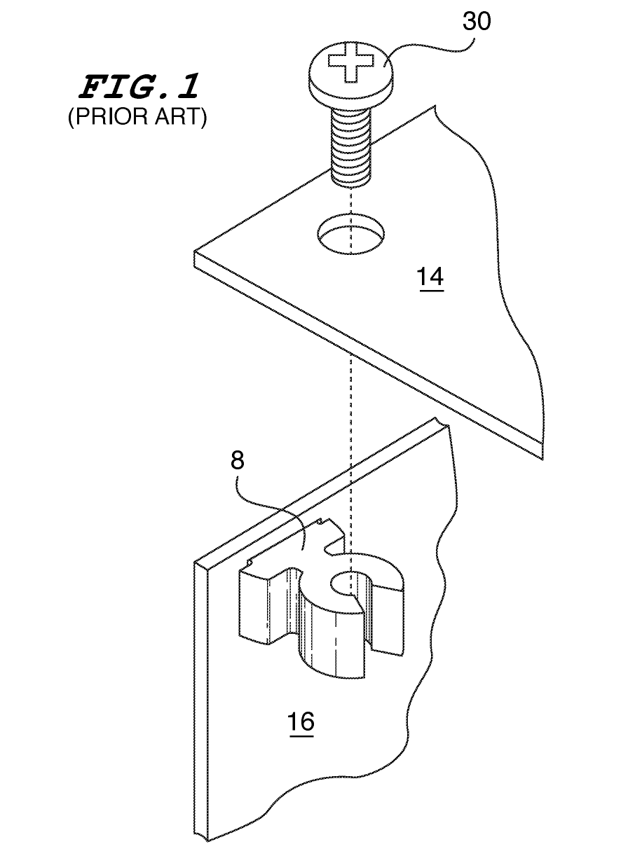

### DESCRIPTION OF THE PREFERRED EMBODIMENT

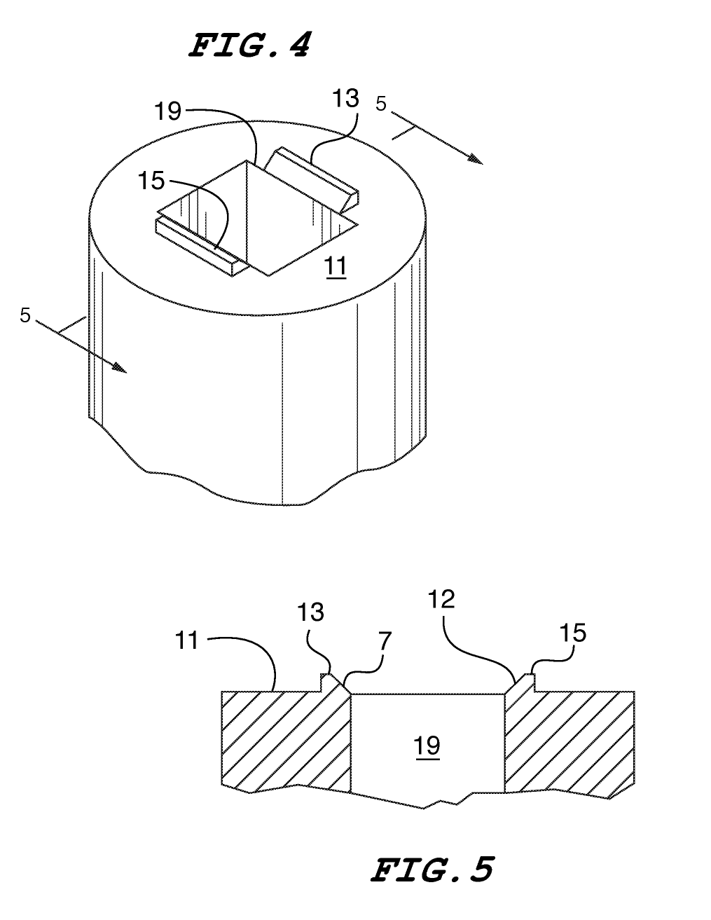

Referring now to FIG. 4, one embodiment of the invention employs an anvil 11 having two raised displacers consisting of protrusions 13 and 15. A close up of these panel displacing protrusions is shown in FIG. 5. As seen in FIG. 5 each of the protrusions has a trapezoidal cross-section with a slanted surfaces 12 and 7 facing inwardly toward the anvil well 17 at approximately 45 degrees from the intersection of the protrusion with a horizontal planar pressing surface. The rear side of each protrusion has a vertical surface on the opposite side which faces away from the anvil well 19.

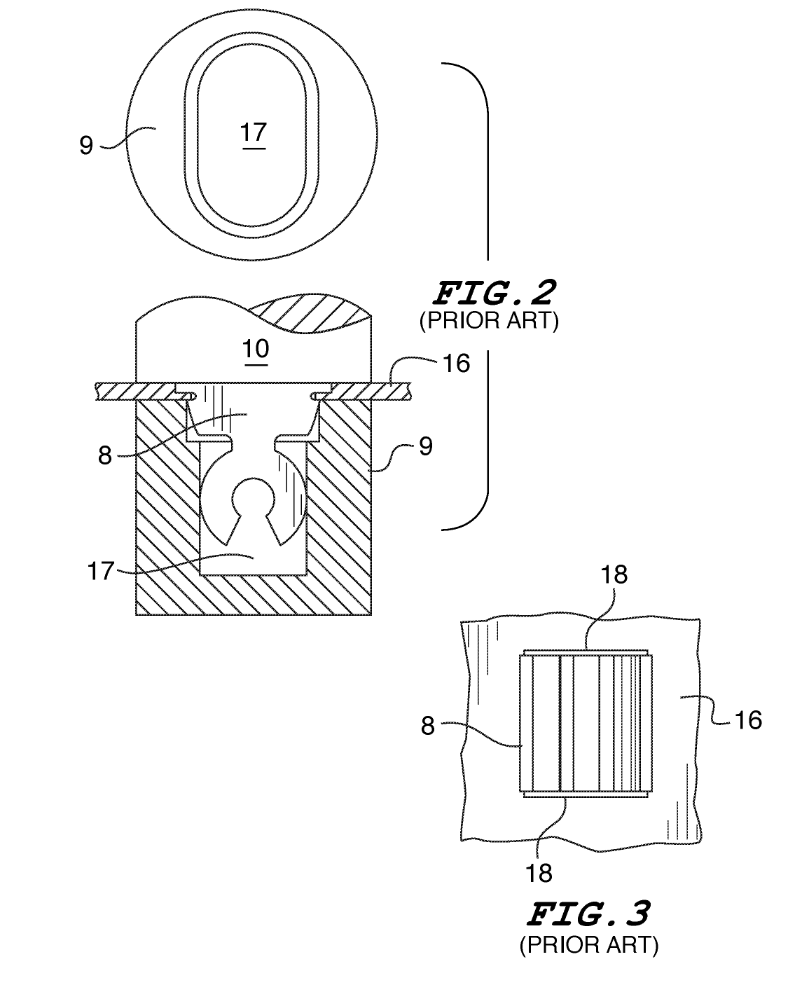

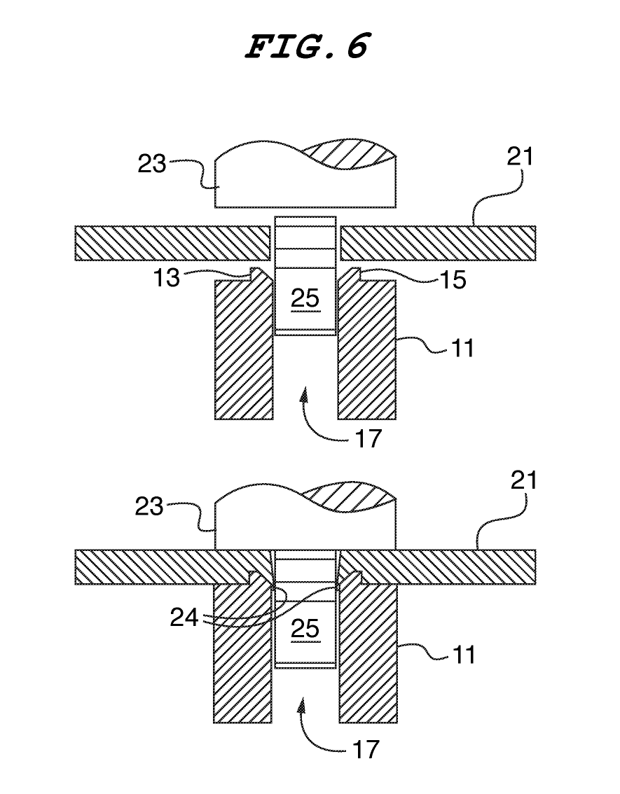

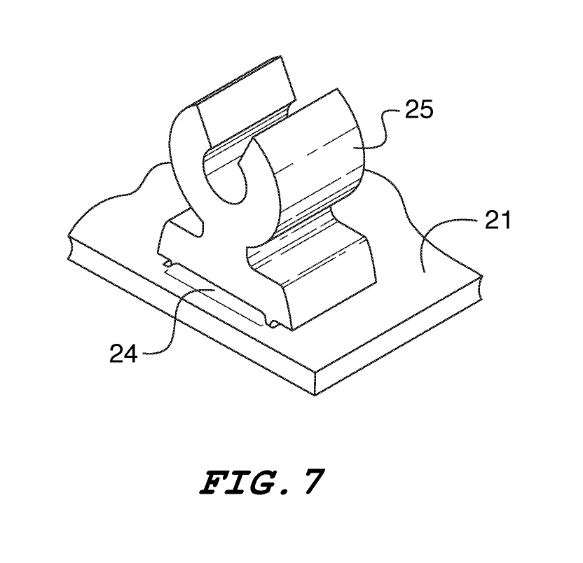

Referring now to FIG. 6, the fastener 25 is shown applied to a panel 21 in a two-part sequence depicted here from the non-clinching side of the fastener which is identical to the fastener 8 seen in FIG. 2. To begin the installation process the fastener is first placed upside down into the anvil well 17 against a panel with an appropriately sized rectangular receiving hole having a side tolerance. A punch 23 is then pressed against the fastener 25 and the anvil 11. In the lower illustration of FIG. 6 we see that after pressing that portions of the side gaps have been closed at least along a medial portion of their length by the displacement of panel material 24 inwardly down against the sides of the fastener 25. It is the nature of the fastener of this embodiment that its lateral sides are featureless and planar so that there is no structural interference with the gap closure along the length of the gap.

After pressing the result is shown in FIG. 7 seen from the side of the panel 21 from which the main body of the fastener 25 projects. Here we see that panel material 24 has been displaced by the anvil displacer protrusions such that the lateral fastener side-gap has been substantially closed by panel material 24 simultaneously as the undercuts on the longitudinal sides of the fastener are also filled with displaced panel material. Minor end portions of the gap which remain open are acceptably short enough that significant EMI emissions will not be produced. This means that electronics enclosures that utilize this fastener attachment tooling will satisfy EMI emission certification requirements.

The foregoing is to be considered illustrative only of the principles and possible embodiments of the invention. Further, since numerous modifications and changes will readily occur to those skilled in the art, it is not desired to limit the invention to the exact construction and operation shown and described. Accordingly, suitable modifications and equivalents may be resorted to, all falling within the scope of the invention which shall be determined only by the following claims and their legal equivalents.

1. A method of attaching a fastener having a rectangular base to a panel having a rectangular receiving hole, comprising the steps of:
placing a panel with a rectangular receiving hole having a length and a width against a top of an anvil having a pressing surface with upward extending projections in alignment with said hole, said anvil further having a well extending downward from directly below said panel hole;
placing a fastener with a rectangular base through the panel receiving hole against a top of the panel and partially into the anvil well, said base having two pairs of parallel opposing sides, a first pair of opposing longitudinal sides having undercuts for receiving the cold flow of material from the panel defining a length of said base and a second pair of opposing lateral sides being planar and featureless and defining a width of said base, the width of said base being less than the receiving hole width such that gaps in the hole exist between the lateral pair of sides of said base and the panel; and
pressing said fastener against the panel and the anvil whereby said projections on the anvil pressing surface displace material of said panel inwardly into said gaps and against the second pair of fastener side edges such that medial portions of said gaps are fully closed while simultaneously material of the panel is forced into said undercuts attaching the fastener to the panel.

2. The method of claim 1 wherein said projections extend upwardly from the sides of the anvil bore.

3. The method of claim 2 wherein the projections have a trapezoidal profile with a front surface facing toward the anvil well and a rear surface facing away from the well, said rear surface extending vertically while the front surface is angled upwardly and away from the bore.

4. The method of claim 3 wherein the front surface extends upwardly at an angle of approximately forty-five degrees from an intersection with the anvil pressing surface.

5. The method of claim 4 wherein the undercuts extend horizontally through the longitudinal sides of the fastener base.

6. The method of claim 5 wherein the base of the fastener lies flush with a top surface of the panel after pressing.

7. An assembly of a fastener affixed to a panel, comprising:
a panel having a rectangular receiving hole with a length and a width:
a fastener with a rectangular base extending through the receiving hole, said base having two pairs of parallel opposing sides, a first pair of longitudinal sides having undercuts receiving the cold flow of material from the panel and a second pair of lateral featureless planar sides; and
gaps between the lateral sides and the panel having medial portions fully closed by the deformation of the panel material against the lateral sides of the fastener performed during attachment of the fastener to the panel.

8. The assembly of claim 7 performed by pressing the fastener and the panel against an anvil having projections on a pressing surface thereof which displace material of the panel inwardly into said gaps.

9. The assembly of claim 8 wherein the projections have a trapezoidal profile with a front surface facing toward the anvil bore and a rear surface facing away from the bore, said rear surface extending vertically while the front surface is angled upwardly and away from the bore.

10. The assembly of claim 9 wherein the front surface extends upwardly at an angle of approximately forty-five degrees from an intersection with the anvil pressing surface.
